(19) United States
(12) Patent Application Publication
(10) Pub. No.: US 2018/0185725 A1
(43) Pub. Date: Jul. 5, 2018

(54) METHOD OF PLAYING A GAME OF FOOTBALL

(71) Applicant: JAY MYERS, LOVELAND, OH (US)

(72) Inventor: JAY MYERS, LOVELAND, OH (US)

(21) Appl. No.: 15/863,622

(22) Filed: Jan. 5, 2018

Related U.S. Application Data
(60) Provisional application No. 62/442,851, filed on Jan. 5, 2017.

(51) Int. Cl. A63B 67/00; G09B 19/22

(52) U.S. Cl. CPC A63B 67/002; A63B 2243/007; G09B 19/22

(57) ABSTRACT

The invention provides for a new method of playing American football. In particular, the method enables the play of football with far fewer, if any, collisions that lead to injury. The system herein provides rules for a fast paced version of American football in which the clock is infrequently stopped and intentional collisions would not happen.

### PREVIOUSLY FILED APPLICATION

This patent application is a non-provisional patent application claiming the benefit of provisional patent application No. 62/442,851 filed on Jan. 5, 2017.

### FIELD OF THE INVENTION

The invention provides for a new method of playing American football. In particular, the method enables the play of football with far fewer, if any, collisions that lead to injury.

### BACKGROUND OF THE INVENTION

American Football (“football”) is under attack because of the risk of injuries, especially brain concussions and chronic traumatic encephalopathy (CTE), due to contact that is fundamental to the sport. Legislative action, lawsuits, or public pressure on sponsors of football broadcasts could find it facing a demand for sudden, drastic changes or even a sudden shutdown.

Sudden, drastic changes might result in a flawed game that today's fans would not watch. If college and/or professional football, a multi-billion dollar industry, faced a sudden shut down, its replacement would be uncertain. Football is an exciting but also a firmly entrenched part of the cultural landscape of America. Rugby would be an unsuitable replacement since it has little cultural appreciation in the United States and can be just as dangerous as football. While soccer is well known amongst youth, it has never garnered the kind of popular or economic support in college or professionally that football has. Flag football is a sport akin to tackle football but without the tackling. Like soccer, it is popular amongst youth but has gained little cachet in either college or professionally. Tackle football continues to reign supreme as the most popular of all the American sports and is the most lucrative sports industry in the United States.

What is needed therefore is a new way to play the game of football that maintains its excitement and its ability to remain a large generator of revenue. The prior art has not contemplated this beyond the creation of flag football that, as shown above, has garnered little interest either collegiately nor professionally.

### SUMMARY OF THE INVENTION

Accordingly, the invention provides a system for playing non-contact American football. The system comprises a standard American football field and uses a standard line of scrimmage as in American football. The system provides for a first team playing offense that has at least five offensive players. It also provides for a second team playing defense that has at least five defensive players to match the offensive players.

The system provides various rules that govern it. For example, the system provides a breakaway rule. The breakaway rule enables an offensive player in possession of a football to run across a line of scrimmage in an attempt to reach the goal line before any defensive player reaches the goal line. Also provided is a kicking rule. The kicking rule enables any offensive player in possession of the football to kick the football to any other offensive player to advance it, such kicking may occur at any point on the field. Another rule is the six step rule. The six step rule requires the offensive player in possession of the football to be limited to no more than six steps while in possession of the football behind a line of scrimmage. Importantly, the system for playing non-contact American football excludes physical tackling at any point during play.

In the system, physical tackling and blocking by physical contact are excluded.

The system for playing non-contact American football herein also comprises a three transfer rule. The three transfer rule limits the number of transfers between the offensive players to no more than three transfers between players. In practice, the three transfer rule applies to all play occurring behind the line of scrimmage.

During game play, each offensive player is subject to the six step rule. The system further comprises a chain rule. The chain rule allows the first team to continue a down when another offensive player catches a pass or captures a kick. Herein, the offensive player in possession of the football is subject to the six step rule.

In play, the system for playing non-contact American football allows for six downs in which to score. If a team has not scored by the end of the six downs, the ball turns over on downs to the other team. In this system, first downs are done away with.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 shows a football field, lateral lines, sidelines, edges, and boxes described herein in EXAMPLE—FIELD PARAMATERS.

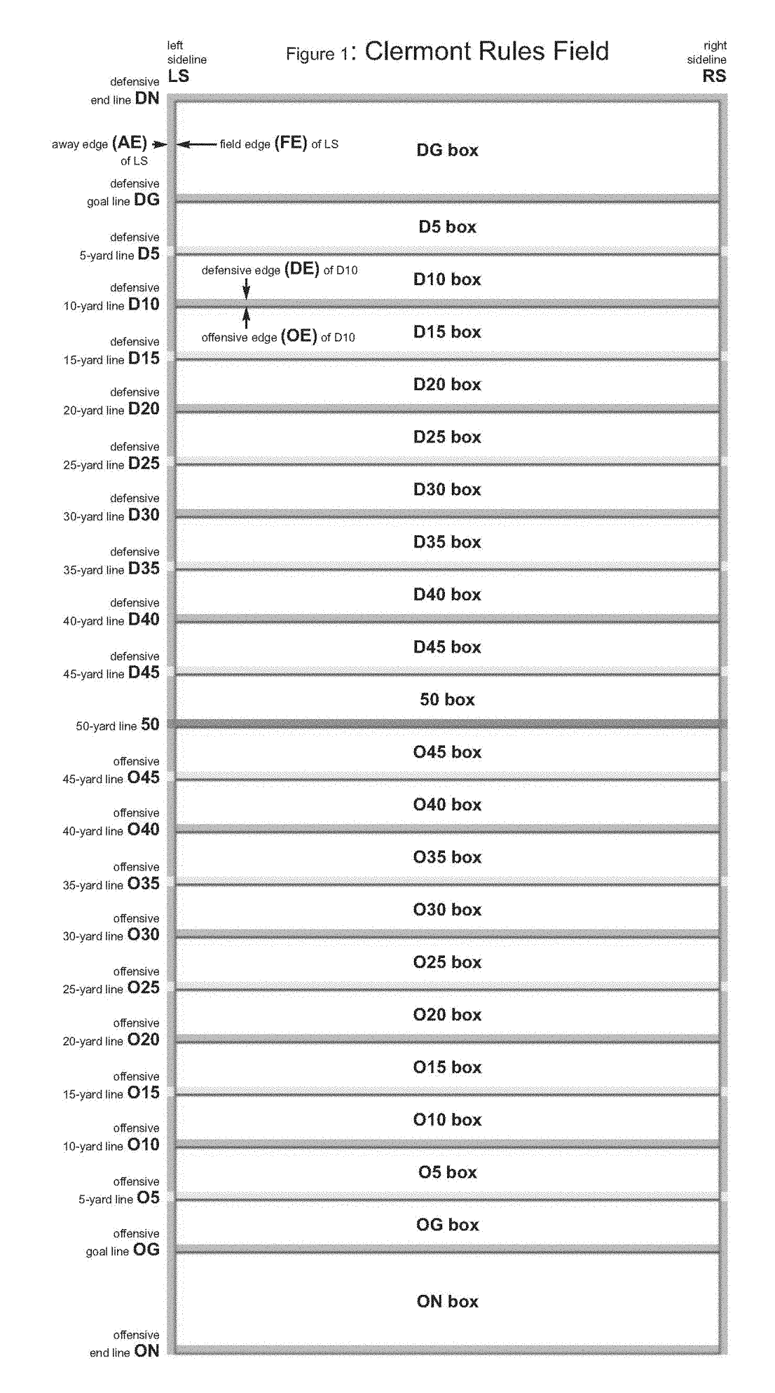

FIG. 2 shows a formation of an offensive team and an opposing defensive team at the beginning of a down as described herein in EXAMPLE—ACTION.

FIG. 3 shows lines of scrimmage and placement of a football at the beginning of a down as described herein EXAMPLE—TERMS OF PLAY.

### DETAILED DESCRIPTION OF THE INVENTION

Provided herein is a new method to play American Football. It serves as an alternative replacement for commonly known tackle football that is geared to make football safer and less injurious while maintaining its excitement and spontaneity. Given its rules, this new method of playing football makes the sport instantly accessible to young, old, boys, girls, men and women.

The invention herein provides a system for playing non-contact American football. The system comprises a standard American football field and uses a standard line of scrimmage as in American football. The system provides for a first team playing offense that has at least five offensive players. It also provides for a second team playing defense that has at least five defensive players to match the offensive players.

The system provides various rules that govern it. For example, the system provides a running rule. The running rule prohibits an offensive player in possession of a football from running across a line of scrimmage unless he or she elects to proceed according to a breakaway rule. The breakaway rule enables an offensive player in possession of a football to run across a line of scrimmage in an attempt to reach the goal line before any defensive player reaches the goal line.

Also provided is a kicking rule. The kicking rule enables any offensive player in possession of the football to kick the football to any other offensive player to advance it, such kicking may occur at any point on the field. Another rule is the six step rule. The six step rule requires the offensive player in possession of the football to be limited to no more than six steps while in possession of the football behind a line of scrimmage. Importantly, the system for playing non-contact American football excludes physical tackling at any point during play.

In the system, physical tackling and blocking by physical contact are excluded. The system for playing non-contact American football herein also comprises of claim 1 further comprising a three transfer rule. The three transfer rule limits the number of transfers between the offensive players to no more than three transfers between players. In practice, the three transfer rule applies to all play occurring behind the line of scrimmage.

During game play, each offensive player is subject to the six step rule. The system further comprises a chain rule. The chain rule allows the first team to continue a down when another offensive player catches a pass or captures a kick. Herein, the offensive player in possession of the football is subject to the six step rule.

In play, the system for playing non-contact American football allows for six downs in which to score. If a team has not scored by the end of the six downs, the ball turns over on downs to the other team. In this system, first downs are done away with.

There many advantages to the system provided herein for playing American styled football. For example, it will generate more fan excitement than tackle or flag because it would be a more open, continuous game. Any player on a team can kick the ball for gain, and—as in some forms of flag—all players are eligible pass receivers.

Additionally, several other key advantages exist. The chain rule generates non-stop action not seen in tackle or flag football. That is, play is not readily stopped because of a dead ball. The breakaway rule is designed to generate exciting “go-for-broke” foot races to the goal line. The three-transfer rule gives plays more time to develop.

Further in game play, the team with the ball can manage the lateral placement of the ball to its advantage. A down can begin as close as one yard away from a sideline. In game play, there would be fewer delays, breaks in the action, and clock stoppages. A team responsible for a ball going out of bounds would incur a penalty, and the clock would not stop. Players and coaches cannot call time-outs. The clock continues to run after an incomplete pass. There would be no measurements because first downs do not exist. Preferably, there would be no instant replay to review any plays.

### Example—Equipment

The ball used in football game herein is a standard American Football (AF) ball.
The Uniform. Players may wear:
Uniforms and shoes like those used in rugby and soccer.
Protective equipment such as shin guards, knee pads, and mouthpieces.
Bandages, braces, wraps, etc., to protect wounds, prevent re-injury, etc.

### Officials' Equipment.

The officials use whistles to control play.
The officials also use flags like those of penalty flags in AF. But in CRF, there are four colors of flags:
(1) A red flag marks a box
(2) A white flag marks a spot of a violation committed by the defense.
(3) A black flag marks a spot of a violation committed by the offense.
(4) A yellow flag marks spots other than the above.
An official throws a red flag into the appropriate box.
An official throws a white, black, or yellow flag at or near the appropriate spot.
The official uses the location of a white, black, or yellow as a guide. He may spot the ball wherever he wishes.

### Example—Field Parameters

The field is a standard AF field.

### Goal Posts.

On a field designed for CRF, the location, width, and design of the goalposts are the same as those on fields designed for professional AF.
When CRF is to be played on a field designed for high school or college play, the goalposts on that field are acceptable.

### Lateral Lines.

Lateral lines are stripes drawn across the field from sideline to sideline:
(1) End lines
(2) Goal lines
(3) Yard lines
Lateral lines are designated as in the following examples, where:
(1) “D” indicates a line on the defensive part of the field, and
(2) “O,” indicates a line on the offensive part.
Defensive end line: DN
Defensive goal line: DG
Defensive 5-yard line: D5
Defensive 10-yard line: D10
50-yard line: 50
Offensive 10-yard line: O10
Offensive 5-yard line: O5
Offensive goal line: OG
Offensive end line: ON
A description of a change of possession uses a designation that applied before the change. So, for example, “the defense takes over the ball on the D30” means “the defense takes over the ball on what had been the D30 and is now the O30.”

### Sidelines.

The left sideline the sideline on the left of a player facing the DN is designated LS.
The right sideline the sideline on the right of a player facing the DN is designated RS.

### Edges.

The offensive edge (OE) of a lateral line is the edge on the offensive side of the line.
The field edge (FE) of a sideline is the edge facing toward the field of play.
The defensive edge (DE) of a lateral line is the edge on the defensive side of the line.
The away edge (AE) of a sideline is the edge facing away from the field of play.
   Boxes. Every line except the DN has a corresponding box, bound by the OE's of two lateral lines and the FE's of two sidelines. For example,
Defensive goal line box (DG box): DG, LS, DN, RS
Defensive 5-yard line box (D5 box): D5, LS, DG, RS
Defensive 45-yard line box (D45 box): D45, LS, D40, RS
50-yard line box (50 box): 50, LS, D45, RS
Offensive 45-yard line box (045 box): O45, LS, 50, RS
Offensive 5-yard line box (05 box): O5, LS, O10, RS
Offensive goal line box (OG box): OG, LS, O5, RS
Offensive end line box (ON box): ON, LS, OG, RS

### Example—Players

### Number of Players.

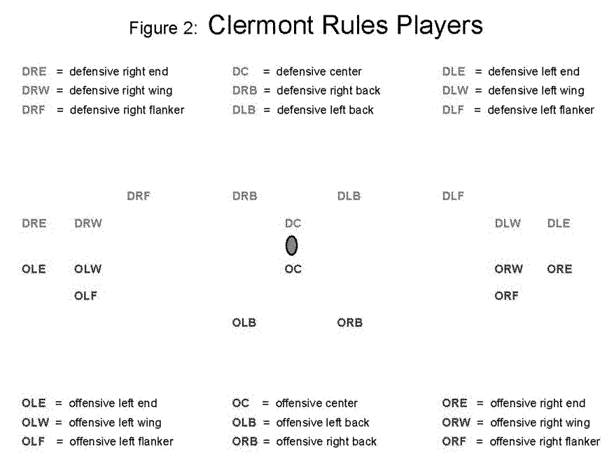

There are nine players on a side.
A team may dress no more than 21 players for a game.
The names of the offensive positions are based on the formation shown in FIG. 2. This is not a required formation. There is no required formation in CRF.
The names of the defensive positions are based on the man-to-man coverage shown in FIG. 2. This coverage is not required. There is no required coverage in CRF.

### Substitution.

Both teams may substitute without limit after:
A down three ends, or
The ball changes hands.

### Example—Officials

There are six officials: one referee, one backfield judge, one line judge, and three downfield judges.
The referee has authority over the other officials.
Decisions of the referee are final.
(1) There is no instant replay.
(2) Players and officials have an equal obligation to ensure that officials can see critical elements of plays. Thus, for example, throwing a pass that arrives at an intended spot of capture (SC; see Spots, below) when no official has a clear view of that spot may be as much a matter of poor play as poor officiating.

### Example—Terms of Play

### Scoring.

Teams may score as follows:
Breakaway touchdown (see The Breakaway Rule, below), 9 points
Touchdown (see Gains and Losses and Interceptions, below), 6 points.
Field goal, (see Kicking for Points, below), 3 points.
Conversion (see Conversion Downs, below), 2 points.
Single (see Kicking for Points, below), 1 point.

### Downs.

The offense has six downs to advance the ball. Those downs are called “down one,” “down two,” “down three,” etc.
The offense cannot make another down one during a given series of six downs.
The offense loses possession of the ball if it fails to score by the end of its down six.
A conversion play is also a down called “down conversion” (see Conversion Downs, below).
A down may begin on a yard line only. That is, unlike in AF, a down may not begin between yard lines.
A down may not begin on the OG or DG. So if, according to certain rules below, a down would begin on the OG or DG, the Add-Five Rule applies:
(1) If the down would begin on the DG, it begins instead on the D5.
(2) If the down would begin on the OG, it begins instead on the O5.

### Lines of Scrimmage.

There are two lines of scrimmage:
(1) The offensive line of scrimmage (OLOS; pronounced OH-loce) is the OE of the yard line.
(2) The defensive line of scrimmage (DLOS; pronounced DEE-loce) is the DE of the yard line.
At the beginning of a down:
(1) the long dimension of the ball is at rest perpendicular to the yard line, and
(2) the end of the ball on the defensive side is directly over the OE.

### Throws.

There are two kinds of throws: tosses and passes.
A toss is a throw to a teammate who is behind the OLOS.
A player may toss the ball in any direction toward, parallel to, or away from the OLOS.
A pass is a throw to a teammate who is beyond the OLOS.

### Catching and Intercepting a Pass.

An offensive player catches a pass if:
He is in full possession of the ball before any part of the ball touches the ground, and
He is at least two boxes beyond the OLOS (see Box of Catch, Capture, or Interception (CCOI), below). This is the Two-Box Rule.
He makes an improper catch if he is in the first box beyond the OLOS. An improper catch is considered improper downfield play, and brings a penalty (see Penalties, below).
A defensive player may intercept a toss or pass in any box. (NOTE: Saying “in any box” is equivalent to saying “anywhere in bounds.”)

### Incomplete Toss or Pass.

If the ball goes out of bounds, a penalty results.
If the ball does not go out of bounds, the next down begins on the SR spot of the OE on which the play.

### Kicks.

A kick is a punt, a place kick, or a drop kick.
All three kinds of kicks are equivalent. Thus, for example, a player may punt, place kick, or drop kick a field goal.

### Capturing a Kick.

An offensive player captures a kick if:
(1) he catches, picks up, or falls on the ball, and
(2) he is at least two boxes beyond the OLOS.
Any offensive player, including the kicker, may capture a kick regardless of whether:
(1) any other player defensive or offensive touches it first, and
(2) the ball touches the ground first.
He makes an improper capture if he is not two boxes beyond the OLOS.
(1) If he is behind the OLOS, he has engaged in improper backfield play, and his team is penalized.
(2) If he is in the first box beyond the OLOS, he has engaged in improper downfield play, and his team is penalized.

### Intercepting a Kick.

A defensive player intercepts a kick if:
(1) he catches, picks up, or falls on the ball, and
(2) he is in any box.
A defensive player may intercept a kick regardless of whether:
(1) any other player—offensive or defensive—touches it first, and
(2) the ball touches the ground first.

### Blocks and Deflections.

Neither an offensive nor a defensive player may deflect the ball deliberately to a teammate.
However, a defensive player may block or bat down a toss, pass, or kick.
A player may not kick a kicked or thrown ball, engaging in soccer-style play.
When the ball is deflected inadvertently, it remains in play as if the deflection had not occurred.
When a pass or kick is blocked, the ball remains in play as if the block had not occurred.

### Spots.

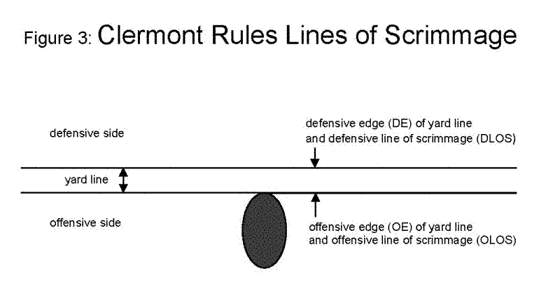

Spot of down (SD): The point at which a down begins. In FIG. 3, the SD is the point on the OE under the ball.
SD placement spot (SD spot): The point on an OE that is the same distance from a given sideline as the SD of the previous play.
Spot of release (SR):
Of a pass: The point where the toe of the passer's forward foot touched the ground before he released the ball.
Of a kick: The point where the toe of the kicker's non-kicking foot touched the ground before he kicked the ball.
   SR placement spot (SR spot): The point on an OE that is the same distance from a given sideline as the SR.
   Spot of catch or spot of capture (SC): The point where the toe of the catcher's or capturer's forward foot touched the ground when he came into possession of the ball or, if he came into possession of the ball with only one foot on the ground or while in mid-air, the point where the toe of what then became the player's forward foot touched the ground.
   SC placement spot (SC spot): The point on an OE that is the same distance from a given sideline as the SC.
   Spot of interception (SI): The point where the toe of the interceptor's forward foot touched the ground when he came into possession of the ball or, if he came into possession of the ball with only one foot on the ground or while in mid-air, the point where the toe of what then became the player's forward foot touched the ground.
   SI placement spot (SI spot): The point on a DE that is the same distance from a given sideline as the SI.
   Spot of violation (SV): The point where the toe of the forward foot of the player who committed the violation touched the ground when he committed the violation; or, if he committed the violation with only one foot on the ground or while in mid-air, the point where the toe of what then became his forward foot touched the ground.
   SV placement spot (SV spot): The point on an OE that is the same distance from a given sideline as the SV.

### Box of Catch, Capture, or Interception (CCOI).

A player is in a given box if both of his feet have touched the ground inside that box, with no part of either foot touching the ground outside the box at that time, and if thereafter
(1) neither foot has touched the ground outside the box, and
(2) no other part of his body has touched the ground outside the box.
A player is considered to have made a CCOI in a given box if he was in the box when he first touched the ball and when he came into possession of the ball.
(1) If he comes into possession of the ball when one foot is in the air, that foot must then touch the ground completely inside the box, with no other part of his body touching the ground outside the box at that time.
(2) If he comes into possession of the ball while he is in mid-air, both feet must then touch the ground completely inside the box, with no other part of his body touching the ground outside the box at that time.
If a player makes a CCOI with his feet and/or other parts of his body in two boxes during the act, he is considered to have made the CCOI in the less forward box. For example,
(1) If an offensive player's feet are in the O30 and O35 boxes during the act of making a catch, he is considered to have made the catch in the O30 box.
(2) If a defensive player's feet are in the O35 and O30 boxes during the act of making an interception, he considered to have made the catch in the O35 box.
When a player makes a CCOI, an official throws a red flag to mark the box in which the CCOI occurred.
That official or another official throws a yellow flag to mark the spot of CCOI.

### Out of Bounds.

A player is out of bounds if:
(1) Either foot or any other part of his body has touched the ground beyond the FE of the LS or RS, the OE of the DN, or the DE of the ON, and
(2) He has not returned to a box.
The ball is out of bounds if:
(1) It touches any part of the field or any object beyond the FE of the LS or RS, or beyond an extension of that FE beyond the DN or ON, or
(2) It touches any part of the field or any object beyond the OE of the DN, or the DE of the ON, or
(3) A player touches or comes into possession of the ball when he is out of bounds, or
(4) A player who possesses the ball and is engaged in backfield play runs out of bounds.
Causing the ball to go out of bounds—deliberately or not—is a violation, and brings a penalty.

### Limits on Obstruction.

No player may deliberately touch an opposing player.
After a player releases the ball by passing or kicking it, no player may obstruct the movement of any opposing player.
If a Player A and a Player B are running toward the same point in pursuit of the ball and are likely to collide, the defensive player must give way.
If a player gets into position for a CCOI when an opposing player is two more running steps away from him, the opposing player may not touch him. A player is position if:
(1) He is within one running step of the anticipated spot of CCOI, and
(2) He is not running; but he may take small steps to adjust his position, as long as he says within one running step of the anticipated spot of CCOI.
In all other situations, a player may obstruct the movement of an opposing player.
If obstruction is permissible and Player B is moving toward Player A, Player A may move backward slowly.
If obstruction is permissible, Player A may set a screen on Player B.

### Screening.

A Player A may set a screen on a Player B who is:
(1) Stationary,
(2) Moving laterally relative to Player A,
(3) Moving away from Player A, or
(4) Moving toward Player A but two or more running steps away from him.
A player may not set a screen while extended.

### Extension.

A player is extended when:
(1) One or both arms are extended to the side,
(2) One or both arms are extended to the front,
(3) One or both feet are extended beyond a vertical line from the outside of the corresponding shoulder, or
(4) One or both feet are extended to the front.
If a Player A is extended and an opposing Player B runs toward him such that Player B would touch an extended part of his body, Player A must retract that part.

### Example—Action

### The Initial SD.

Before a game begins, the visiting team selects the end of the field that it wishes to defend in the first quarter (see Length of Game, below).
The game begins with the visiting team on offense and the SD on the 020 and midway between the LS and RS.
The referee marks the SD by placing his flag next to the ball.

### Initiating a Down.

The OC initiates play on every down.
(1) On down one and a conversion down, any offensive player may assume the role of OC.
(2) On downs two through six, the last offensive player to handle the ball behind the OLOS assumes the role of OC.
To initiate play, the OC takes his position.
(1) He must have both hands on the ball. He may not change the location or orientation of the ball. When he puts his hands on the ball, small, incidental movements of the ball are permissible.
(2) The rest of his body must be behind the OLOS.
(3) After taking his position, he may not move any part of his body until puts the ball into play.
The referee stands on the defense's side of the DLOS so that the offensive players can easily see him.
The backfield judge stands on the offense's side of the OLOS so that the defensive players can easily see him.

### The Countdown.

Immediately after the OC takes his position, the referee counts down.
(1) First, he announces the down: for example, “Down three.”
(2) Then, with the words one second apart, he says, “Two, one, set, two, one, set.”
As the referee counts down vocally, he and the backfield judge also count down manually.
(1) When the referee announces the down number, they extend a number of fingers corresponding to the down.
(2) They pump their right fists as the referee says “Two, one, set, two, one, set.”
Both teams must form up by the end of the first “set.”
(1) The offensive players must form up behind the OLOS, but not at any particular distance behind it.
(2) The defensive players must form up behind the DLOS, but not at any particular distance behind it.
After the teams form up, they may not move until the OC puts the ball into play.
The OC may not put the ball into play before the end of the second “set.”

### The Six-Step Rule.

The OC puts the ball into play by picking it up.
He must then take immediate action. He may not stand still with the ball. He may not walk with the ball.
He may:
(1) dispose of the ball immediately (see Disposing of the Ball, below),
(2) engage in backfield play, or
(3) use the Breakaway Rule.
To engage in backfield play, he must run with the ball, staying behind the OLOS.
His run may include:
(1) one through six steps, and
(2) the time he has both feet off the ground after his sixth step.
By the end of his run, he must have disposed of the ball.

### Disposing of the Ball.

A player may dispose of the ball by:
(1) Handing the ball to any teammate who is behind the OLOS,
(2) Tossing the ball to any teammate who is behind the OLOS,
(3) Placing and holding the ball for a place kick by any teammate, or
(4) Attempting to advance the ball by passing or kicking.
After disposing of the ball, he must remain behind the OLOS for one additional step.

### The Three-Transfer Rule.

The player who receives a handoff or toss from the OC may take the same actions as the OC was permitted to take.
Play may continue in this manner until three transfers have occurred that is, until the ball has been handed off or thrown three times, including the initial transfer from the OC.
An inadvertent deflection by an offensive player counts as a transfer.
The offense may advance the ball beyond the OLOS either:
(1) Without transferring the ball, or
(2) After one, two, or three transfers.

### Gains.

The offense scores a touchdown if, as a result of a penalty,
(1) The ball would be placed on the DG, or
(2) The ball would cross the DG.
The offense scores a touchdown when an offensive player makes a catch or capture in the DG box.
When he makes a catch or capture elsewhere, he must decide immediately whether to:
(1) End the down (see Ending a Down, below),
(2) Use the Chain Rule (see The Chain Rule, below), or
(3) Use the Breakaway Rule.
The offense scores a breakaway touchdown if an offensive player uses the Breakaway Rule successfully.

### Losses and Interceptions.

The defense scores a touchdown if, as a result of a penalty,
(1) the ball would be placed on the OG, or
(2) the ball would cross the OG.
The defense scores a touchdown when a defensive player makes an interception in the OE box.
When he makes an interception elsewhere, he must decide immediately whether to:
(1) End the down,
(2) Use the Chain Rule, or
(3) Use the Breakaway Rule.
The defense can score a touchdown by using the Chain Rule.
The defense scores a breakaway touchdown if a defensive player uses the Breakaway Rule successfully.

### Ending a Down—General.

A player ends a down by raising his right hand.
If he falls to the ground in the act of catching or capturing, he must get to his feet immediately and raise his right hand.
   Offense Ends a Down 1 through 5.
When an offensive player ends a down, the next down begins on the SC spot of a yard line.
When he ends a down 1, 2, 3, 4, or 5, the next down begins on the next line closer to the DN. For example,
(1) If he ends the down in the D10 box, the next down begins on the D5.
(2) If he ends the down in the D35 box, the next down begins on the D30.
(3) If he ends the down in the O35 box, the next down begins on the O40.
ADD-FIVE EXCEPTION: Because of the Add-Five Rule, if he ends a down in the D5 box, the next down begins on the D5 instead of the DG.

### Offense Ends a Down 6.

When an offensive player ends a down 6 in any box, the defense takes over the ball on the SC spot of the line corresponding to that box. For example,
(1) If he ends the down in the D5 box, the defense takes over the ball on the D5
(2) If he ends the down in the D35 box, the defense takes over the ball on the D35.
(3) If he ends the down in the O35 box, the defense takes over the ball on the O35.

### Offense Runs Out of Downs.

When the offense fails to score on a down 6 because no one caught a pass or captured a kick during that down, the defense takes over the ball on the SD spot of the next line closer to the ON. For example,
(1) If the down began on the O10, the defense takes over the ball on the O5.
(2) If the down began on the O35, the defense takes over the ball on the O30.
(3) If the down began on the D35, the defense takes over the ball on the D40.
ADD-FIVE EXCEPTION: Because of the Add-Five Rule, if the down began on the O5, the defense takes over the ball on the O5 instead of the OG.

### Defense Ends a Down.

When a defensive player ends a down, the next down begins on the spot of CCOI on the next line toward the ON. Examples:
(1) If he ends the down in 05 box, the next down begins on the O5.
(2) If he ends the down in the O35 box, the next down begins on the O35.
(3) If he ends the down in the D35 box, the next down begins on the D35.
   ADD-FIVE EXCEPTION: Because of the Add-Five Rule, if he ends the down in the OG box, the next down begins on the O5 instead of the OG.

### The Chain Rule—General.

In chain play,
(1) The player who made the CCOI assumes a role similar to that of the OC at the beginning of a down,
(2) The OE or DE of a lateral line that defines the box of CCOI assumes the role of the OLOS at the beginning of a down (see The Chain Rule Line of Scrimmage, below),
(3) The Six-Step Rule applies,
(4) The Three-Transfer Rules applies,
(5) The Two-Box Rule applies, and
(6) Play proceeds as described above, beginning with The Six-Step Rule, and as described in The Chain Rule Action, below.
If a player makes a CCOI during chain play, he may continue chain play. In other words, “a chain may have many links.”
A team is not charged a down for engaging in chain play.

### The Chain Rule—Line of Scrimmage.

An official will throw a red flag to indicate the box of CCOI. The OE or DE of the next line in the direction of the opponent's goal assumes the role of the OLOS. For example,
(1) If an offensive player makes a catch or capture in the D10 box, the OE of the D5 assumes the role of the OLOS.
(2) If a defensive player makes an interception in the D10 box, the DE of the D10 assumes the role of the OLOS.

### ADD-FIVE EXCEPTIONS: Because of the Add-Five Rule,

If an offensive player makes a catch or capture in the D5 box, the OE of the D5—instead of the DG—assumes the role of the OLOS,
If a defensive player makes an interception in the OG box, the DE of the O5—instead of the OG—assumes the role of the OLOS.

### The Chain Rule—Action.

There is no break in the action from the first play of a down and the first chain play of that down.
There is no break in the action between any of the “links of a chain” in a down.
If, in making a CCOI, a player goes beyond the edge that assumes the role of the OLOS, or if, after making the CCOI, his momentum carries him beyond that edge,
(1) He must run immediately to the box of CCOI, and
(2) The steps needed to get to that box count toward his six-step maximum. No other player needs to go to any particular box.

### The Breakaway Rule.

A player in possession of the ball during a down may make a breakaway run if no opposing player is in the box beyond the opposing team's goal line. That is,
(1) A offensive player may make a breakaway run if no defensive player is in the DG box, and
(2) A defensive player may make a breakaway run if no offensive player is in the ON box.
A player makes a breakaway run by running the ball across the OLOS, directly toward the goal line, and then across the goal line.
He may make the run no matter how many steps he has already taken.
No opposing player may obstruct his movement.
If he crosses the goal line before any opposing player, he scores a breakaway touchdown.
If an opposing player crosses the goal line ahead of him, his team is penalized for improper backfield play.

### Kicking for Points.

If an offensive player captures a kick in the DG box, the offense scores a touchdown, as previously indicated.
If a kick travels between the uprights of the defense's goal posts, the offense scores a field goal.
If a kick travels over the OE of the DN, but does not travel between the uprights, the offense scores a single.
(1) The kick must travel over the DN itself, not an extension of the DN to the left of the LS or the right of the RS.
(2) The kick may touch the ground before traveling over the DN.
A team may also kick a conversion, as described below.

### Conversion Downs.

The offense runs a conversion down after scoring a breakaway touchdown or a touchdown.
A conversion down begins on the D10 and midway between the sidelines.
Play proceeds as described in The Countdown, above, with the down called “conversion down” in the referee's countdown.
The offense may score a conversion by:
(1) Kicking the ball between the uprights,
(2) Capturing a kick in the DG Box, or
(3) Catching a pass in the DG Box.
The offense may not score a single on an unsuccessful conversion attempt.
Violations.
(1) If the defense commits a violation, the offense scores a conversion.
(2) If the offense commits a violation, the down ends. The offense is not penalized further.

### Example—Clock

### Length of Game.

A game consists of four quarters of 20 minutes each.
An intermission between the first and second halves lasts 15 minutes.
There are 3-minute rests after the first and third quarters.
The teams change goals at the end of each quarter.

### Time Between Downs.

If the clock continues to run after a down, the offense has 25 seconds from the end of that down to put the ball into play on the next down.
If the referee stops, then restarts the clock, the offense must put the ball into play no more than 25 seconds after the restart.

### Overtime and Ties.

If the score is tied after four quarters, the teams rest for 10 minutes, then play a fifth quarter of 20 minutes.
If the game is tied after the fifth quarter, the teams rest for 3 minutes, then play a sixth quarter of 10 minutes.
Play continues in this manner—with additional 3-minute rests and 10-minute quarters—until one team is leading at the end of a quarter.

### Stopping the Clock.

The referee may stop the clock whenever he wishes.
An official must stop the clock if:
(1) The ball goes out of bounds,
(2) An official calls a penalty on the team that has the ball, or
(3) A player is injured.

### Restarting.

Only the referee may restart the clock.
He may restart the clock whenever he wishes.
His guidelines for restarts are:
(1) Ball out of bounds: Restart when an official who is in bounds receives the ball.
(2) Penalty: Restart after spotting the ball.
(3) Injury: Restart after the player is replaced or indicates that he is in condition to play.

### End-of-Quarter Situations.

If a down is in progress when the clock runs out at what would have been the end of a quarter, that down continues as if the clock were still running.
The clock does not stop for a conversion down.
If a touchdown occurs on a down that is in progress at what would have been the end of the first, second, or third quarter, the next quarter begins with the conversion down.
If a touchdown occurs on a down that is in progress at what would have been the end of the fourth quarter or an overtime quarter, and the touchdown ties the game, the next quarter begins with the conversion down.
If a touchdown occurs on a down that is in progress at what would have been the end of the fourth quarter or an overtime quarter, and the touchdown does not tie the game, the game ends. The team that scored does not get a conversion down.

### Penalties

A team may refuse a penalty.
When both teams commit violations, the referee may assess a penalty for either violation or neither violation.
The offense scores a touchdown if, as a result of a penalty,
(1) The ball would be placed on the DG, or
(2) The ball would cross the DG.
The defense scores a touchdown if, as a result of a penalty,
(1) The ball would be placed on the OG, or
(2) The ball would cross the OG.
There are 11 classes of violation:
(1) Improper substitution
(2) Improper formation
(3) Improper movement
(4) Starting a down too early or too late
(5) Improper backfield play
(6) Improper downfield play
(7) Improper obstruction
(8) Deliberate deflection to a teammate, or kicking a kicked or thrown ball
(9) Ball out of bounds
(10) Violation not otherwise described
(11) Personal foul

### Assessments—Violations by the Offense.

Class (1) through (4):
(1) 10 yards from the SD, and
(2) The offense is not charged a down.
Class (5) through (10), offense not engaged in chain play:
(1) 10 yards from the SV spot on the OLOS, and
(2) The offense is charged a down.
Class (5) through (10), offense engaged in chain play:
(1) 10 yards from the SD spot on the OE that assumed the role of the OLOS, and
(2) The offense is charged a down.
Class (5) through (10), defense engaged in chain play: Of the following, the penalty that puts the defense in a better position:
(1) 10 yards from the SV spot on the DE that assumed the role of the OLOS, or
(2) 10 yards from the SV spot on the DE of the line corresponding to the box in which violation occurred.
Class (11): The referee may assess whatever penalty he wishes, including but not limited to loss of down, loss of distance, ejection of player, ejection of coach, and forfeiture of game.

### Assessments—Violations by the Defense.

Class (1) through (3):
(1) 10 yards from the SD, and
(2) the offense is not charged a down.
Class (7) through (10), offense not engaged in chain play: Of the following, the penalty that puts the offense in a better position:
(1) 10 yards from the SV spot on the OE of the next line toward the DN, or
(2) 10 yards from the SV spot on the OLOS.
Class (7) through (10), offense engaged in chain play: Of the following, the penalty that puts the offense in a better position:
(1) 10 yards from the SV spot on the OE of the next line toward the DN, or
(2) 10 yards from the SV spot on the OE that assumed the role of the OLOS.
Class (5) through (10), defense engaged in chain play: Of the following, the penalty that puts the offense in a better position:
(1) 10 yards from the SV spot on the DE of the next line toward the DN, or
(2) 10 yards from the SV spot on the DE that assumed the role of the OLOS.
Class (11): The referee may assess whatever penalty he wishes, including but not limited to loss of distance, ejection of player, ejection of coach, and forfeiture of game.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for playing non-contact American football, comprising:
a. A standard American football field;
b. A first team playing offense, said first team having at least five offensive players;
c. A second team playing defense, said second team having at least five defensive players to match said offensive players;
d. A line of scrimmage used during play;
e. A breakaway rule, said breakaway rule enabling an offensive player in possession of a football to run across a line of scrimmage in an attempt to reach the goal line before any defensive player;
f. A kicking rule, said kicking rule enabling any offensive player in possession of said football to kick said football to any other offensive player to advance; and
g. A six step rule, said six step rule requiring said offensive player in possession of said football to be limited to no more than six steps while in possession of said football behind a line of scrimmage,
Whereby said system for playing non-contact American football excludes physical tackling at any point during play.

2. The system for playing non-contact American football of claim 1 wherein said system excludes physical contact blocking between players.

3. The system for playing non-contact American football of claim 1 further comprising a three transfer rule, said three transfer rule limiting the number of transfers between said offensive players to no more than three said transfers.

4. The system for playing non-contact American football of claim 3 wherein said three transfer rule applies to all play occurring behind said line of scrimmage.

5. The system for playing non-contact American football of claim 4 wherein each said offensive player is subject to said six step rule.

6. The system for playing non-contact American football of claim 1 further comprising a chain rule, said chain rule said first team to continue a down when another said offensive player catches a pass or intercepts a kick.

7. The system for playing non-contact American football of claim 6 wherein said offensive player in possession of said football is subject to said six step rule.

8. The system for playing non-contact American football of claim 1 wherein said first team has six downs in which to score.

9. The system for playing non-contact American football of claim 8 wherein said first team cannot earn a first down.
